(19) United States
(12) Patent Application Publication
(10) Pub. No.: US 2015/0328509 A1
(43) Pub. Date: Nov. 19, 2015

(54) GOLF FLAG POLE AND GOLF GAME

(71) Applicant: H & H, LLC, Milford, OH (US)

(72) Inventor: Mark S. Hartwell, Milford, OH (US)

(21) Appl. No.: 14/714,758

(22) Filed: May 18, 2015

Related U.S. Application Data
(60) Provisional application No. 62/000,042, filed on May 19, 2014.

(51) Int. Cl. A63B 57/00; G09F 17/00

(52) U.S. Cl. CPC A63B 57/00; G09F 17/00; A63B 2243/0029

(57) ABSTRACT

A golf game flag pole for use in a golf game includes a rod having a base rod portion and an upper rod portion. A flexible element joins the base portion and the upper portion. The base rod portion is configured to be insertable into the ground. The flexible element allows the upper rod portion to be bent or pivoted relative to the base rod portion so that the upper rod portion is generally parallel to the ground. The base rod portion may be inserted into a ground surface, whereby the upper rod portion extends generally upwardly from the ground surface. When a golf ball towards the flag pole, the flag pole can be bent or flexed so that the upper rod portion is generally parallel to the ground and the players can determine if the hit golf ball is within a ground area swept by the upper rod portion.

### CROSS REFERENCE TO RELATED APPLICATION

The present application claims the filing benefits of U.S. provisional application Ser. No. 62/000,042, filed May 19, 2014, which is hereby incorporated herein by reference in its entirety.

### FIELD OF THE INVENTION

The present invention relates generally to golf and, more particularly, to games of golf.

### SUMMARY OF THE INVENTION

The present invention provides a golf flag pole that can be used by a consumer to set up a target, such as for a game with other users or the like. The golf flag pole comprises a rod and a flag or marker at the upper end of the rod. The rod includes a base portion that can be inserted into the ground and an upper portion that is flexibly attached at the base portion and with the flag or marker at an upper end of the upper rod portion. The upper rod portion functions as a measuring stick (when bent at the flexible portion so that the upper rod portion is generally parallel to the ground) to determine when a player hits his or her golf ball within a predetermined distance from the base portion.

Thus, the present invention provides a flag pole and golf game and method of playing a golf game, wherein a player may insert the base rod portion of the flag pole into the ground (or optionally insert the base rod portions of a plurality of flag poles into the ground to set up a course), whereby the rod portions extend generally vertically upward from the ground. The player or players may then hit their golf balls towards the flag pole from a selected distance away. Then, if one or more of the hit golf balls appears to be relatively close to the flag pole, the players may determine if the ball is within an appropriate distance to be considered “in the hole” by bending the flag pole at the flexible portion, whereby the upper rod portion (which has a length that is the “appropriate distance to be considered in the hole”) determines if the hit golf ball is within the appropriate distance. If the golf ball is within the selected distance or predetermined distance (which may be set by a marker or flag along the upper rod portion of the flag pole), then that player's shot is considered to be “in the hole” and that player need not hit again.

These and other objects, advantages, purposes, and features of the present invention will become apparent upon review of the following description in conjunction with the drawings.

### BRIEF DESCRIPTION OF THE DRAWINGS

FIG. 1 is a view of a plurality of flag poles for a golf game in accordance with the present invention; and

FIG. 2 is a view showing use of the flag pole to determine whether or not a golf ball is close enough to be considered “in the hole” in accordance with the present invention.

### DESCRIPTION OF THE PREFERRED EMBODIMENTS

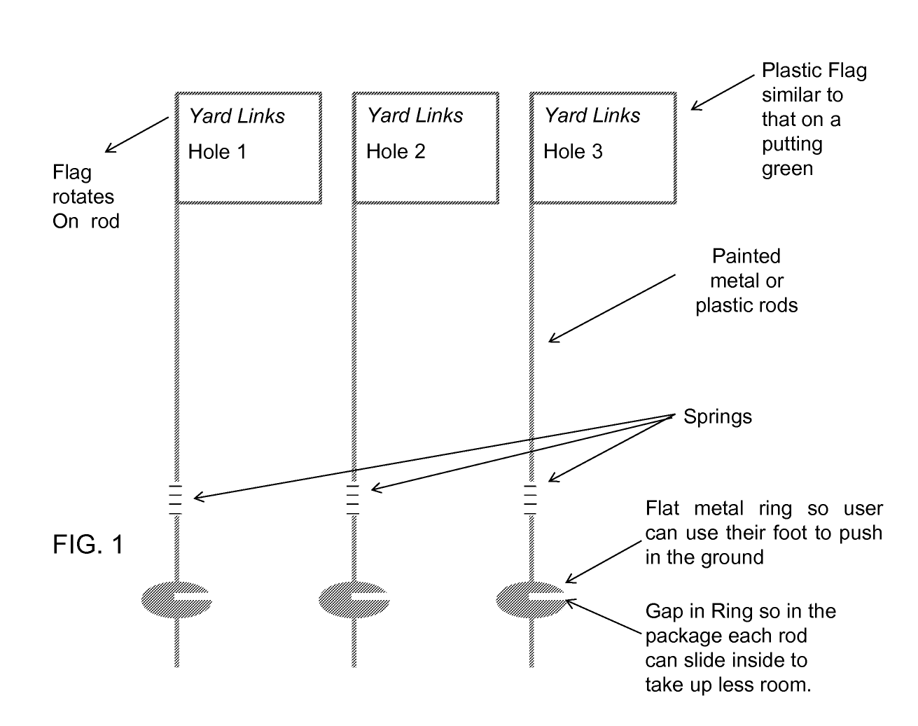

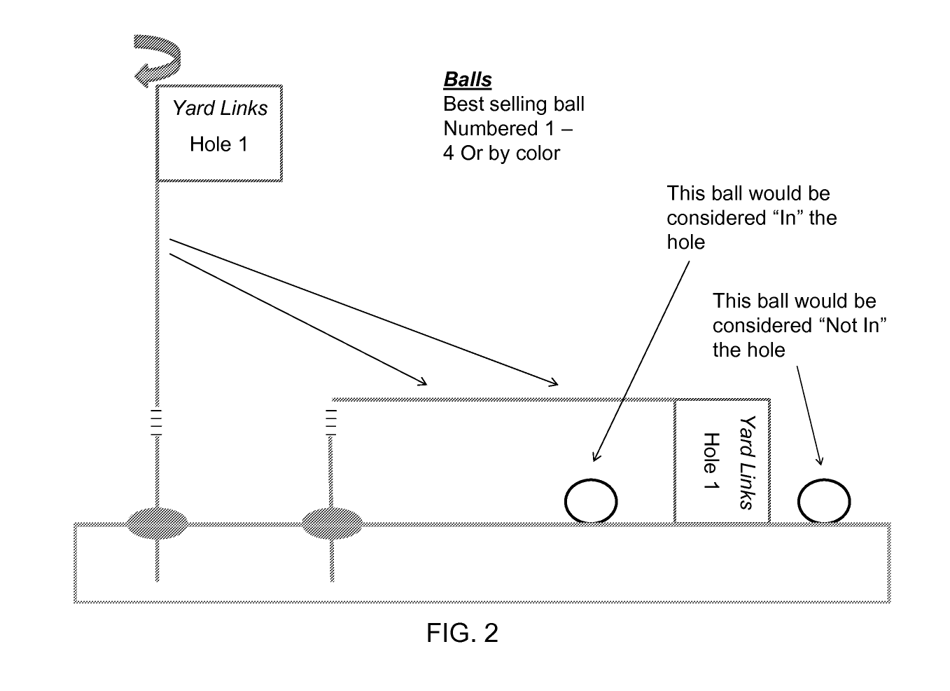

As shown in FIGS. 1 and 2, a golf game and golf flag pole of the present invention includes a flag pole that has a base portion or lower rod portion and an upper rod portion that is pivotably or bendably attached at an upper end of the lower rod portion. The lower rod portion is configured for insertion into the ground, whereby the upper rod portion extends generally vertically upward from the lower rod portion. The upper rod portion of the flag pole rod may be bent or pivoted (such as shown in FIG. 2) relative to the lower rod portion to determine if a hit ball is within the predetermined or selected distance from the base portion or lower rod portion of the flag pole.

Optionally, multiple flag poles may provide a course where people hit golf balls towards the flag poles and can readily determine whether or not the hit golf ball is within a certain difference or close enough so as to be considered to be “in the hole” to complete that player's shots for that hole of the course. The flag pole rod may be plastic or metal and includes a flexible portion, such as a coiled spring or other suitable hinge-like or flexible element or portion, which allows for bending of the flag pole or rod so that the upper rod portion is generally parallel to the ground at which the lower portion of the flag pole or rod is inserted.

Optionally, the lower rod portion may include a plate to ease insertion of the rod into the ground. As shown in FIG. 1, the plate may include a notch or slot to allow for nesting of multiple flag poles along one another (with a rod portion of one flag pole being received in the slot of another flag pole) to ease packaging of multiple flag poles. Optionally, the upper rod portion may rotate relative to the lower portion to allow the user to bend the flag and sweep the upper portion 360 degrees about the base portion to determine how close multiple golf balls are to the flag pole. Optionally, the flag may rotate about the upper rod portion so that the flag hangs downward as shown in FIG. 2 throughout the rotation of the upper rod portion relative to the lower rod portion.

Thus, the present invention provides a golf game that allows a user to set up one or more golf “holes” or a golf course (by inserting or otherwise anchoring the lower rod portions of the flags at desired locations), such as in their back yard or other open area. The players of the game may hit their golf balls towards the flag poles or targets and then may readily determine when the hit ball or shot is within a distance close enough to be considered in the hole. As shown in FIG. 2, if the ball is within a distance swept or spanned by the upper rod portion (or optionally within a distance between the lower rod portion and a lower end of the flag or marker), the ball may be considered in the hole.

Optionally, the flag or marker may be adjustably positioned along the upper rod portion so that the “hole size” or distance may be adjusted (whereby someone could make the course more difficult by lowering the flag or marker along the upper rod portion, or whereby a different setting or position of the flag may be made for different handicaps of the players playing the game against each other). For example, a first player may have a lower handicap than a second player, so the first player's flag position may be lower or closer to the base rod portion than the second player's flag position.

Changes and modifications to the specifically described embodiments may be carried out without departing from the principles of the present invention, which is intended to be limited only by the scope of the appended claims as interpreted according to the principles of patent law including the doctrine of equivalents.

1. A golf flag pole comprising:
a rod having a base rod portion and an upper rod portion;
a flexible element joining said base portion and said upper portion;
wherein said base rod portion is configured to be insertable into the ground; and
wherein said flexible element is configured to allow said upper rod portion to be bent or pivoted relative to said base rod portion so that said upper rod portion is generally parallel to the ground.

2. The golf flag pole of claim 1, comprising a flag or marker at an upper region of said upper rod portion.

3. The golf flag pole of claim 2, wherein said flag or marker is adjustably positioned along said upper rod portion.

4. The golf flag pole of claim 1, wherein said upper rod portion is rotatable relative to said lower rod portion so as to be able to sweep a generally circular ground area around said base rod portion when bent or flexed.

5. The golf flag pole of claim 1, wherein said flexible element comprises a spring.

6. A golf game comprising:
at least one flag pole comprising a base rod portion and an upper rod portion flexibly attached at said base rod portion and pivotable relative to said lower rod portion;
wherein, with said base rod portion inserted into a ground surface, said upper rod portion extends generally upwardly from the ground surface;
wherein, after a golf ball is hit towards said flag pole, said flag pole is bent or flexed so that said upper rod portion is generally parallel to the ground; and
wherein it is determined whether or not the hit golf ball is within a ground area swept by said upper rod portion.

7. The golf game of claim 6, wherein multiple flag poles are used to establish a course.

8. The golf game of clam 6, comprising a flag or marker at an upper region of said upper rod portion.

9. The golf game of claim 8, wherein said flag or marker is adjustably positioned along said upper rod portion.

10. The golf game of claim 6, wherein said upper rod portion flexes relative to said lower rod portion via a flexible element.

11. The golf game of claim 10, wherein said flexible element comprises a spring.

12. The golf game of claim 6, wherein said upper rod portion is rotatable relative to said lower rod portion so as to be able to sweep a generally circular ground area around said base rod portion when bent or flexed.

13. A method of playing a golf game comprising:
providing a flag pole comprising a base rod portion and an upper rod portion flexibly attached at said base rod portion and pivotable relative to said lower rod portion;
inserting said base rod portion into a ground surface, whereby said upper rod portion extends generally upwardly from the ground surface;
hitting a golf ball towards said flag pole;
bending or flexing said flag pole so that said upper rod portion is generally parallel to the ground; and
determining if the hit golf ball is within a ground area swept by said upper rod portion.

14. The method of claim 13, wherein multiple flag poles are provided to establish a course.

15. The method of claim 13, comprising rotating said upper rod portion relative to said lower rod portion to sweep a generally circular ground area around said base rod portion when bent or flexed.

16. The method of clam 15, wherein said flag pole comprises a flag or marker at an upper region of said upper rod portion, and wherein said method comprises adjusting the position of said flag or marker along said upper rod portion to adjust the size of an area swept by said flag or marker, and wherein determining if the hit golf ball is within a ground area swept by said upper rod portion comprises determining if the hit golf ball is within a ground area swept by said flag or marker of said upper rod portion.

17. The method of clam 13, wherein said flag pole comprises a flag or marker at an upper region of said upper rod portion.

18. The method of claim 17, comprising adjusting the position of said flag or marker along said upper rod portion to adjust the size of an area swept by said flag or marker, and wherein determining if the hit golf ball is within a ground area swept by said upper rod portion comprises determining if the hit golf ball is within a ground area swept by said flag or marker of said upper rod portion.

19. The method of claim 13, wherein said upper rod portion flexes relative to said lower rod portion via a flexible element.

20. The method of claim 19, wherein said flexible element comprises a spring.
